(19) United States
(12) Patent Application Publication
(10) Pub. No.: US 2019/0143995 A1
(43) Pub. Date: May 16, 2019

(54) CONTENT SELECTION SYSTEM, CONTENT PLAYBACK DEVICE, CONTENT SELECTION SERVER, AND CONTENT SELECTION METHOD

(71) Applicant: HONDA MOTOR CO., LTD., Tokyo (JP)

(72) Inventors: Naohide Aizawa, Tokyo (JP); Mitsuhiro Baba, Tokyo (JP)

(21) Appl. No.: 16/315,809

(22) PCT Filed: Jun. 7, 2017
(86) PCT No.: PCT/JP2017/021198

§ 371 Date: Jan. 7, 2019

(30) Foreign Application Priority Data
Jul. 15, 2016 (JP) 2016-140543

(51) Int. Cl. B60W 40/09; B60W 40/105; B60W 40/04; H04N 21/45

(52) U.S. Cl. CPC B60W 40/09; B60W 40/105; B60W 2040/0818; H04N 21/4524; B60W 40/04

(57) ABSTRACT

A content selection server according to the present invention includes: a reception unit configured to receive a current location of a vehicle; a storage unit which stores advisory information about one or more objects that exist on one or more roads and require attention on driving; a transmission unit configured to transmit information; and a control unit which can select a content to be played back. The control unit includes a driving concentration level setting unit configured to obtain a driving concentration level (STEP 31) and, based on the obtained driving concentration level, the current location of the vehicle (STEP 31), and the advisory information (STEPS 32 to 33), and selects at least one category of the content to be played back (STEP 34).

### TECHNICAL FIELD

The present invention relates to a content selection system, a content playback device, a content selection server, and a content selection method.

### BACKGROUND ART

In recent years, with proliferation of the Internet and wireless communication networks, technologies for streaming delivery of contents, such as music and audio, and further, movies and the like, through IP (Internet Protocol) communication have become commonplace. In vehicles too, it is possible to enjoy streaming contents by bringing a mobile wireless terminal such as a smartphone into a vehicle, or with a content playback device such as an Internet radio player mounted in a vehicle.

Of such streaming contents, a server can select a content based on viewer property data. Accordingly, by using location information such as a current location or a destination, it is possible to play back a content based on the current location, or to play back a content according to the destination, in a vehicle.

For example, Japanese Patent Laid-Open No. 2009-289244 discloses a server device which determines a traveling environment of an automobile, such as a congested road, an expressway, a specific location or area, and weather, selects a music track that matches with a music selection condition based on the traveling environment, and transmits the music track to the automobile.

Japanese Patent Laid-Open No. 2006-266807 discloses an information processing device which, upon receiving an input of a destination, selects playlist data according to the destination and plays back music tracks corresponding to a playlist.

### CITATION LIST

### Patent Literature

Patent Literature 1: Japanese Patent Laid-Open No. 2009-289244
Patent Literature 2: Japanese Patent Laid-Open No. 2006-266807

### SUMMARY OF INVENTION

### Technical Problem

A conventional streaming radio, which plays back a content during a drive, only selects a station based on a traveling environment at a certain spot (point of time) or plays back a program prearranged according to a destination, and does not give consideration to a viewing environment of a viewer.

For example, in the invention disclosed in Japanese Patent Laid-Open No. 2009-289244, since a music track is selected based on a traveling environment at a certain spot (point of time), it was not possible to provide a content in anticipation of a traveling environment of a road along which the automobile is going to travel. In addition, consideration was not given to a viewing environment of a viewer.

In the invention disclosed in Japanese Patent Laid-Open No. 2006-266807, a playlist is selected based on a destination, which is a point of arrival in future. However, it was not possible to play back a music track (content) other than the music tracks arranged in a predetermined order based on the playlist data. In addition, similarly to Patent Literature 1, consideration was not given to a viewing environment of a viewer.

In light of the foregoing, an object of the present invention is to provide a content selection system which can select a content in anticipation of a traveling environment through which a vehicle is going to travel, while consideration is given to a viewing environment of a viewer.

### Solution to Problem

[1] In order to achieve the above object, a content selection server according to the present invention comprises:

a reception unit configured to receive a current location of a vehicle;

a storage unit which stores advisory information about one or more objects that exist on one or more roads and require attention on driving;

a transmission unit configured to transmit information; and

a control unit which can select a content to be played back,

wherein the control unit

comprises a driving concentration level setting unit configured to obtain a driving concentration level, which is an indicator of a state where a driver should concentrate on driving, and

selects at least one category of the content to be played back based on the obtained driving concentration level, the current location of the vehicle, and the advisory information.

According to the present invention, it is possible to select a content in anticipation of a traveling environment of a road along which the vehicle is going to travel, while consideration is given to a viewing environment of a viewer.

[2] In the content selection server according to the present invention, the reception unit can receive a traveling speed of the vehicle, and the control unit can be configured to obtain the driving concentration level based on the traveling speed of the vehicle received by the driving concentration level setting unit.

According to such a configuration, a suitable content can be selected according to the concentration level of the driver on driving operation because when the traveling speed of the vehicle changes, the concentration level of the driver on driving operation also changes.

[3] In the content selection server according to the present invention, the control unit can be configured to calculate a traveling speed of the vehicle from changes in the current location of the vehicle, and the driving concentration level setting unit can be configured to obtain the driving concentration level based on the calculated traveling speed of the vehicle.

According to such a configuration, even if a component which directly measures the traveling speed of the vehicle is not included, the driving concentration level can be obtained by obtaining the traveling speed from changes in the current location information.

[4] In the content selection server according to the present invention, the reception unit can receive or estimate a vehicle density on a road along which the vehicle travels, and the control unit can be configured to obtain the driving concentration level based on the vehicle density.

According to such a configuration, a suitable content can be selected according to the concentration level of the driver on driving operation because the concentration level of the driver also changes with vehicle density such as the congestion state of a driving lane. Note that for the vehicle density, a traffic counter on a road may be used, or the vehicle density may be estimated by compiling current location information uploaded to the server from a plurality of vehicles.

[5] In the content selection server according to the present invention, the control unit can be configured to select one or more objects that exist on a road within a predetermined distance from the current location of the vehicle and require attention on driving, to calculate a sum of points of advisory level of the selected one or more objects that exist on the road and require attention on driving, and to set the advisory information based on a sum of points.

According to such a configuration, a more suitable content can be selected by appropriately grasp a traveling environment through which the vehicle is going to travel.

[6] In the content selection server according to the present invention, the storage unit stores a plurality of contents and category-specific tag information associated with each of the contents, the control unit can be configured to read the content corresponding to the selected at least one category from the storage unit in a case where the at least one category of the content to be played back is selected by the control unit, and the transmission unit can be configured to transmit the read out content.

According to such a configuration, it is possible to enjoy a content selected in anticipation of a traveling environment through which the vehicle is going to travel, while consideration is given to a viewing environment of the viewer such as the driver or a passenger.

[7] In the content selection server according to the present invention, the storage unit stores proficiency information about a proficiency level of a driver who drives the vehicle, and the control unit can be configured to select the at least one category of the content to be played back based on the current location of the vehicle, the driving concentration level, the advisory information, and the proficiency information.

According to such a configuration, it is possible to enjoy a content selected in anticipation of a traveling environment through which the vehicle is going to travel, while consideration is given to a viewing environment of the viewer such as the driver or a passenger.

[8] Moreover, a content playback device according to the present invention comprises:

a reception unit configured to receive a current location of a vehicle;

a storage unit which stores advisory information about one or more objects that exist on one or more roads and require attention on driving; and

a control unit which can select a content to be played back,

wherein the control unit

comprises a driving concentration level setting unit configured to obtain a driving concentration level, which is an indicator of a state where a driver should concentrate on driving, and

selects at least one category of the content to be played back based on the obtained driving concentration level, the current location of the vehicle, and the advisory information.

According to the present invention, it is possible to select a content in anticipation of a traveling environment of a road along which the vehicle is going to travel, while consideration is given to a viewing environment of a viewer.

[9] In the content playback device according to the present invention, the control unit can receive a traveling speed of the vehicle, and the control unit can be configured to obtain the driving concentration level based on the traveling speed of the vehicle received by the driving concentration level setting unit.

According to such a configuration, a suitable content can be selected according to the concentration level of the driver on driving operation because when the traveling speed of the vehicle changes, the concentration level of the driver on driving operation also changes.

[10] In the content playback device according to the present invention, the control unit can be configured to calculate a traveling speed of the vehicle from changes in the current location of the vehicle, and the driving concentration level setting unit can be configured to obtain the driving concentration level based on the calculated traveling speed of the vehicle.

According to such a configuration, even if a component which directly measures the traveling speed of the vehicle is not included, the driving concentration level can be obtained by obtaining the traveling speed from changes in the current location information.

[11] In the content playback device according to the present invention, the reception unit can receive or estimate a vehicle density on a road along which the vehicle travels, and the control unit can be configured to obtain the driving concentration level based on the vehicle density.

According to such a configuration, a suitable content can be selected according to the concentration level of the driver on driving operation because the concentration level of the driver also changes with vehicle density such as the congestion state of a driving lane.

[12] In the content playback device according to the present invention, the control unit can select one or more objects that exist on a road within a predetermined distance from the current location of the vehicle and require attention on driving, can calculate a sum of points of advisory level of the selected one or more objects that exist on the road and require attention on driving, and can set the advisory information based on a sum of points.

According to such a configuration, a more suitable content can be selected by appropriately grasp a traveling environment through which the vehicle is going to travel.

[13] In the content playback device according to the present invention, the storage unit stores a plurality of contents and category-specific tag information associated with each of the contents, and the control unit can be configured to read the content corresponding to the selected at least one category from the storage unit in a case where the at least one category of the content to be played back is selected by the control unit, and to play back the read out content.

According to such a configuration, it is possible to enjoy a content selected in anticipation of a traveling environment through which the vehicle is going to travel, while consideration is given to a viewing environment of the viewer such as the driver or a passenger.

[14] In the content playback device according to the present invention, the storage unit stores proficiency information about a proficiency level of a driver who drives the vehicle, and the control unit can be configured to select the at least one category of the content to be played back based on the current location of the vehicle, the driving concentration level, the advisory information, and the proficiency information.

According to such a configuration, it is possible to enjoy a content selected in anticipation of a traveling environment through which the vehicle is going to travel, while consideration is given to a viewing environment of the viewer such as the driver or a passenger.

[15] Furthermore, a content selection method according to the present invention comprises:

a current location step of obtaining a current location of a vehicle;

an advisory information selection step of, by a content selection device, based on the obtained current location, selecting advisory information about one or more objects that exist on a corresponding road and require attention on driving;

a driving concentration level setting step of, by the content selection device, obtaining a driving concentration level, which is an indicator of a state where a driver should concentrate on driving; and

a content selection step of, by the content selection device, selecting at least one category of the content to be played back based on the obtained driving concentration level, the current location of the vehicle, and the selected advisory information.

According to the present invention, it is possible to select a content in anticipation of a traveling environment of a road along which the vehicle is going to travel, while consideration is given to a viewing environment of a viewer.

[16] The content selection method according to the present invention can be configured to further comprise: a vehicle speed step of receiving a traveling speed of the vehicle, and the driving concentration level setting step can be configured such that the driving concentration level is obtained based on the received traveling speed of the vehicle.

According to such a configuration, a suitable content can be selected according to the concentration level of the driver on driving operation because when the traveling speed of the vehicle changes, the concentration level of the driver on driving operation also changes.

[17] The content selection method according to the present invention can be configured to further comprise: a vehicle speed step of calculating a traveling speed of the vehicle from changes in the current location of the vehicle, and the driving concentration level setting step can be configured such that the driving concentration level is obtained based on the calculated traveling speed of the vehicle.

According to such a configuration, even if a component which directly measures the traveling speed of the vehicle is not included, the driving concentration level can be obtained by obtaining the traveling speed from changes in the current location information.

[18] The content selection method according to the present invention can be configured to further comprise: a density step of receiving or estimating a vehicle density of a road on which the vehicle travels, and the driving concentration level setting step can be configured such that the driving concentration level is obtained based on the vehicle density.

According to such a configuration, a suitable content can be selected according to the concentration level of the driver on driving operation because the concentration level of the driver also changes with vehicle density such as the congestion state of a driving lane.

[19] In the content selection method according to the present invention, the advisory information selection step can be configured such that a plurality of objects that exist on the road within a predetermined distance from the current location of the vehicle and require attention on driving are selected, a sum of points of advisory level of the selected plurality of objects is calculated, and the advisory information is set based on the sum of points.

According to such a configuration, a more suitable content can be selected by appropriately grasp a traveling environment through which the vehicle is going to travel.

[20] In the content selection method according to the present invention, a storage unit stores a plurality of contents and category-specific tag information associated with each of the contents, and the content selection method can be configured to further comprise: a reading step of reading, from the storage unit, the content corresponding to the at least one category of the content to be played back selected in the content selection step; and a transmission step of transmitting the read content.

According to such a configuration, it is possible to enjoy a content selected in anticipation of a traveling environment through which the vehicle is going to travel, while consideration is given to a viewing environment of the viewer such as the driver or a passenger.

[21] The content selection method according to the present invention can be configured to further comprise: a proficiency step of reading proficiency information about a proficiency level of the driver who drives the vehicle, and the content selection step can be configured such that the at least one category of the content to be played back is selected based on the current location of the vehicle, the driving concentration level, the advisory information, and the proficiency information.

According to such a configuration, it is possible to enjoy a content selected in anticipation of a traveling environment through which the vehicle is going to travel, while consideration is given to a viewing environment of the viewer such as the driver or a passenger.

[22] Further, a content selection system according to the present invention is a content selection system which selects a content to be delivered from a delivery server, and received and played back by a content playback device, and comprises:

a reception unit configured to receive a current location of a vehicle;

a storage unit which stores advisory information about one or more objects that exist on one or more roads and require attention on driving;

a transmission unit configured to transmit information; and

a control unit which can select a content to be played back,

wherein the control unit

comprises a driving concentration level setting unit configured to obtain a driving concentration level, which is an indicator of a state where a driver should concentrate on driving, and

selects at least one category of the content to be played back based on the obtained driving concentration level, the current location of the vehicle, and the advisory information.

[23] In the content selection system according to the present invention, the reception unit can receive a traveling speed of the vehicle, and the control unit can be configured to obtain the driving concentration level based on the traveling speed of the vehicle received by the driving concentration level setting unit.

[24] In the content selection system according to the present invention, the control unit can be configured to calculate a traveling speed of the vehicle from changes in the current location of the vehicle, and the driving concentration level setting unit can be configured to obtain the driving concentration level based on the calculated traveling speed of the vehicle.

[25] In the content selection system according to the present invention, the reception unit can receive or estimate a vehicle density of a road on which the vehicle travels, and the control unit can be configured to obtain the driving concentration level based on the vehicle density.

[26] In the content selection system according to the present invention, the control unit can be configured to select one or more objects that exist on a road within a predetermined distance from the current location of the vehicle and require attention on driving, to calculate a sum of points of advisory level of the selected one or more objects that exist on the road and require attention on driving, and to set the advisory information based on the sum of points.

[27] In the content selection system according to the present invention, the storage unit stores a plurality of contents and category-specific tag information associated with each of the contents, the control unit can be configured to read the content corresponding to the selected at least one category from the storage unit in a case where the at least one category of the content to be played back is selected by the control unit, and the transmission unit can be configured to transmit the read out content.

[28] In the content selection system according to the present invention, the storage unit stores proficiency information about a proficiency level of the driver who drives the vehicle, and the control unit can be configured to select the at least one category of the content to be played back based on the current location of the vehicle, the driving concentration level, the advisory information, and the proficiency information.

### BRIEF DESCRIPTION OF DRAWINGS

FIG. 1 is an explanatory diagram showing a first embodiment of a content selection system according to the present invention.

FIG. 2 is a block diagram showing a content playback device in the first embodiment.

FIG. 3 is an explanatory diagram showing a mobile wireless terminal in the first embodiment.

FIG. 4 is an explanatory diagram showing a server in the first embodiment.

FIG. 5 is an explanatory diagram showing a level of each content stored in a content area in the first embodiment.

FIG. 6 is an explanatory diagram showing traffic event advisory information in the first embodiment.

FIG. 7 is an explanatory diagram showing content selection references in the first embodiment.

FIG. 8 is a flowchart of the first embodiment.

FIG. 9A is an explanatory diagram showing content selection references for a driver with a high driving proficiency level in a second embodiment, and FIG. 9B is an explanatory diagram showing content selection references for a driver with a low driving proficiency level in the second embodiment.

FIG. 10 is an explanatory diagram showing content selection references used when a content is selected by using a vehicle density in a fourth embodiment.

### DESCRIPTION OF EMBODIMENTS

### First Embodiment

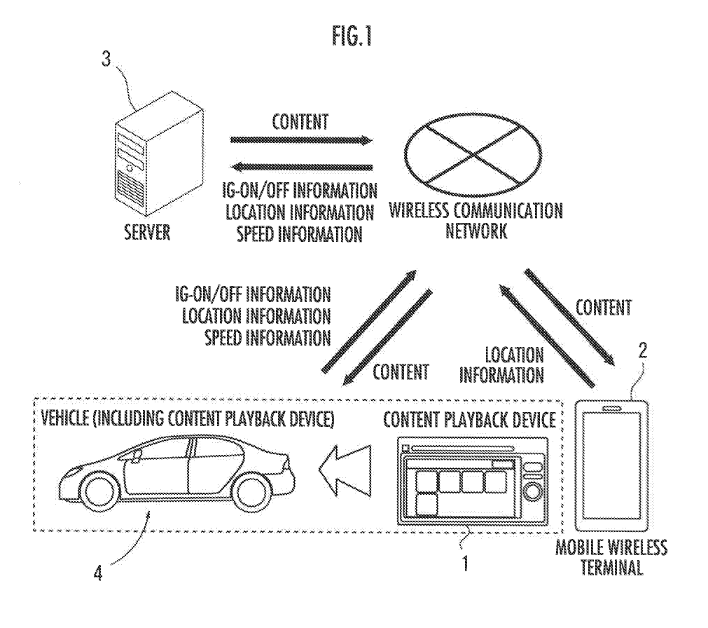

FIG. 1 shows a first embodiment of a content selection system according to the present invention.

The content selection system of the present embodiment includes a content playback device 1 and a server 3 (a content selection device), which are connected through a wireless communication network. Note that in the present embodiment, a device mounted in a vehicle 4 is used for the content playback device 1 to give a description. However, the content playback device according to the present invention is not limited to such a device, and a mobile wireless terminal 2 may be used in place of the content playback device 1 in the present embodiment.

The content playback device 1 in the present embodiment is mounted in the vehicle in a portable or fixed manner. The content playback device 1 is a device that is capable of playing back various types of contents including audio contents such as music, radio, and various announcements, and video contents such as still images and movies. The content playback device 1 is configured to provide services such as various entertainments and calling of attention to a driver and a passenger by playing back a content.

The content playback device 1 may be configured to acquire from the vehicle 4 information on an ON/OFF state of an activation switch (ignition switch) of the vehicle 4, on a vehicle speed (a traveling speed of the vehicle 4), and further on a current location. The content playback device 1 uploads the location information acquired from the vehicle 4, or own location information, to the server 3 by using public radio periodically or when necessary. More preferably, the content playback device 1 uploads to the server 3 the own information on ON/OFF of the activation switch (ignition switch) (IG-ON/IG-OFF) for starting an engine and for activating an EV system.

The content playback device 1 further uploads the information on the speed during a drive to the server 3 when necessary. The server 3 that has received such information selects a suitable content from among contents stored in the server 3 based on the information and delivers the content to the vehicle 4. The vehicle 4 that has received the content plays back the content. Note that when the mobile wireless terminal 2 is used in place of the content playback device 1 mounted in the vehicle 4, the information on IG-ON/IG-OFF is not used. Alternatively, a component for acquiring the information on IG-ON/IG-OFF from the vehicle 4 is provided, whereby the information on IG-ON/IG-OFF can be used. The information on the traveling speed of the vehicle 4 can also be estimated from changes over time (time series variation) in the location information.

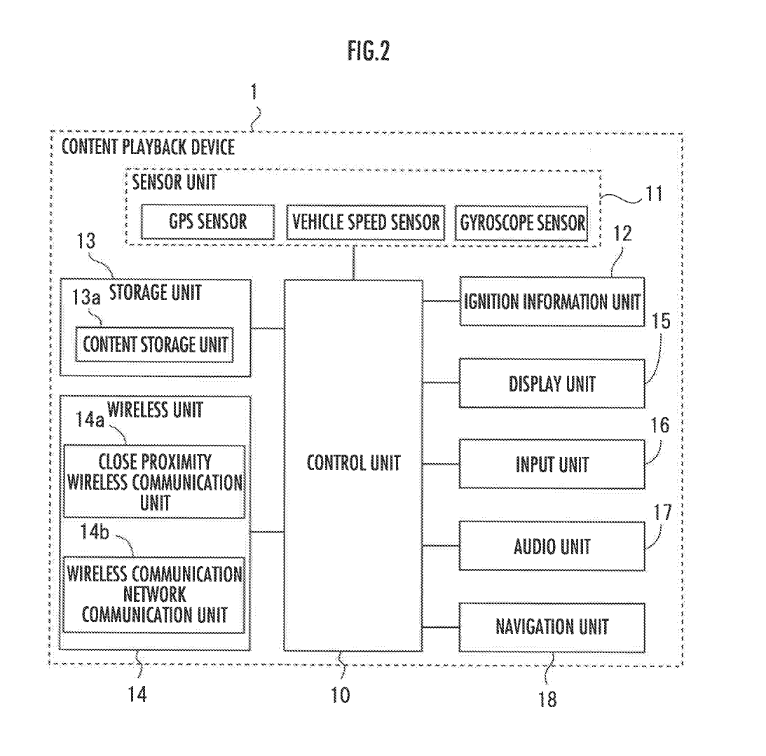

FIG. 2 shows a block diagram of the content playback device 1.

Reference numeral 10 denotes a control unit. The control unit 10 includes a microprocessor and the like and is configured to control each component unit, which will be described later.

Reference numeral 11 denotes a sensor unit, which includes a GPS sensor, a vehicle speed sensor, a gyroscope sensor, and the like. The GPS sensor calculates a current location based on a signal from a GPS (Global Positioning System) satellite. The vehicle speed sensor calculates a speed of the vehicle based on a pulse signal from a drive shaft. The gyroscope sensor senses an angular velocity. With the GPS sensor, the vehicle speed sensor, and the gyroscope sensor, the current location and the direction of the vehicle 4 can be accurately calculated. Sensors including the GPS sensor, the vehicle speed sensor, and the gyroscope sensor may be provided outside the content playback device 1, for example, may be included in the vehicle 4. In such a case, the information from the sensors can be captured by the content playback device 1 through a close proximity wireless communication unit 14a or the like, which will be described later.

Reference numeral 12 denotes an ignition information unit. The ignition information unit 12 is configured to detect information from the activation switch (ignition switch) for starting the engine of the vehicle 4 and activating the EV system of the vehicle 4 by acquiring CAN (Controller Area Network) information on the vehicle 4. With the ignition information, a state of the engine as to whether or not the engine is started (the EV system is activated) can be grasped.

Reference numeral 13 denotes a storage unit (storage media). The storage unit 13 includes a semiconductor memory, a hard disk, and the like and stores software referred to as an operating system (OS) and an application, and further, various types of information such as map information and driver profile information.

The driver profile information refers to an age, a gender, a birth date, various preferences, and the like of a driver, and also to information on a service usage status and the like, such as content delivery service subscription information, and further to information on a type of the vehicle the driver drives. Moreover, the driver profile information includes a driving proficiency level of the driver (a level of driver skill).

The storage unit 13 in the present embodiment stores software configured to play back a content received from the server 3, in addition to software configured to control operations of the control unit 10. In order to play back a content without receiving the content from the server 3, a content storage unit 13a may be provided so that the content can be stored beforehand or by being downloaded on each occasion.

Reference numeral 14 denotes a wireless unit. In the wireless unit 14, reference character 14a denotes the close proximity wireless communication unit, which performs communication with the vehicle 4 and other wireless devices through wireless communication connection technologies such as Wi-Fi (Wireless Fidelity(R)) and Bluetooth(R). If the vehicle 4 side comprises the various sensors such as the GPS sensor, the vehicle speed sensor, and the gyroscope sensor, measurement information is acquired from the vehicle 4 through the close proximity wireless communication unit 14a.

Note that although the measurement information is acquired from the vehicle 4 side through the close proximity wireless communication in the present embodiment, a configuration may also be made such that the information from the sensors is acquired through wired connection. In this case, acquisition of the information from the sensors can be achieved by additionally providing a connector unit for the wired connection.

Reference character 14b denotes a wireless communication network communication unit, which can communicate with the server 3 by connecting to a wireless communication network typified by a mobile telephone network such as 3G, cellular, or LTE communication.

Reference numeral 15 denotes a display unit, which displays various types of information such as a content received from the server 3 or read from the content storage unit 13a and played back, information about a content (a music track name, an artist name, and the like) if the content is audio information, a map around a current location, and route guidance information.

Reference numeral 16 denotes an input unit, which includes a physical switch referred to as a numeric keypad and/or a touch panel. The touch panel is configured together with the display unit 15 in a single form.

Reference numeral 17 denotes an audio unit, which outputs an audio portion of a content received from the server 3 or read from the content storage unit 13a and played back. The audio unit 17 includes an amplifier, a speaker, and the like.

Reference numeral 18 denotes a navigation unit, which outputs a map around a current location on which a vehicle location is overlaid, and, when a destination is set, provides route guidance to the destination.

The components as described above have many commonalities with components of a vehicle-mounted navigation device. By allowing the vehicle-mounted navigation device to comprise the components of the content playback device 1 in the present embodiment by using software or the like, it is possible to implement functions of the content playback device 1 in the present embodiment without incurring a significant increase in cost.

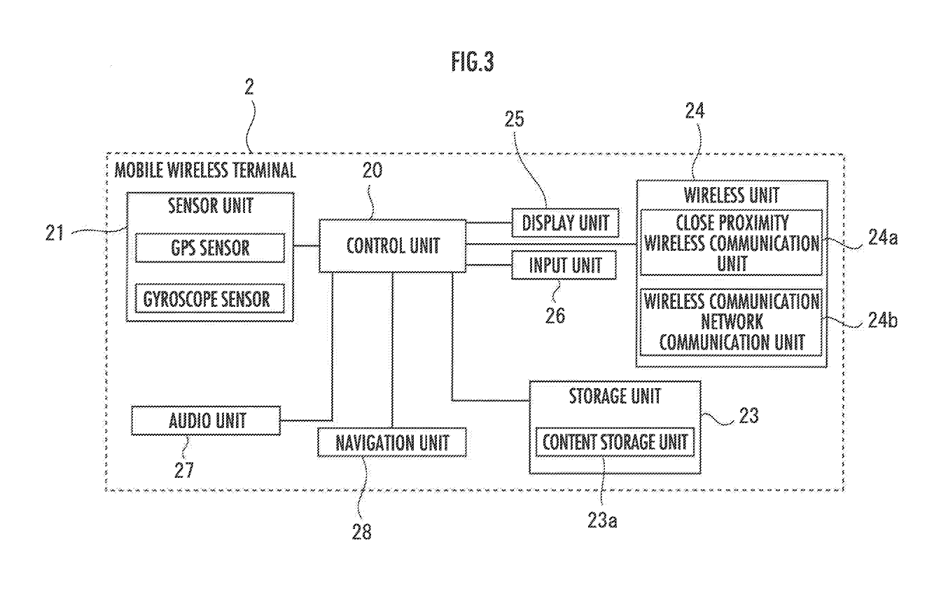

The mobile wireless terminal 2 shown in FIG. 3 will be described. The mobile wireless terminal 2 collectively refers to a smartphone, a tablet terminal, a mobile telephone, and further, various types of wearable terminals that are capable of public wireless communication connection. The mobile wireless terminal 2 can install various types of application software. The present embodiment is configured such that content playback in the present embodiment can also be implemented by the application software installed in the mobile wireless terminal 2.

Reference numeral 20 denotes a control unit. The control unit 20 includes a microprocessor and the like and is configured to control each component unit, which will be described later.

Reference numeral 21 denotes a sensor unit of the mobile wireless terminal 2. The sensor unit 21 includes a GPS sensor and a gyroscope sensor, with which the mobile wireless terminal can grasp a current location of the mobile wireless terminal. Note that the current location can also be calculated based on information on a base station in a wireless communication network acquired from a wireless unit 24, or also can be acquired from the vehicle through a close proximity wireless communication unit 24a, which will be described later.

Note that since the sensor unit 21 of the mobile wireless terminal 2 does not comprise a vehicle speed sensor, the traveling speed of the vehicle 4 cannot be directly measured. However, the traveling speed of the vehicle 4 can be acquired from the vehicle 4 through the close proximity wireless communication unit 24a, or can be calculated from time series variation in location information acquired by the GPS sensor.

Reference numeral 23 denotes a storage unit (storage media) of the mobile wireless terminal 2. The storage unit 23 includes a semiconductor memory and the like, and stores software referred to as an operating system (OS) and an application, and further stores user profile information. The user profile information refers to an age, a gender, a birth date, various preferences, and the like of a user, and also information on a service usage status and the like, such as content delivery service subscription information. The user profile information further includes a driving proficiency level of the driver (a level of driver skill).

The storage unit 23 can be configured to also store control software for navigation and map information, and further, route guidance information. As other software, software configured to play back a content received from the server 3 is stored. In order to play back a content without receiving the content from the server 3, a content storage unit 23a may be provided so that the content can be stored beforehand or by being downloaded on each occasion.

Reference numeral 24 denotes a wireless unit of the mobile wireless terminal 2. In the wireless unit 24, reference character 24a denotes the close proximity wireless communication unit, which performs communication with the vehicle and other wireless devices through wireless communication connection technologies such as Wi-Fi (Wireless Fidelity(R)) and Bluetooth(R).

Reference character 24b denotes a wireless communication network communication unit, which can communicate with the server 3 by connecting to a wireless communication network typified by a mobile telephone network such as 3G or cellular.

Conceivable data to be transmitted includes location information, the above-described user profile information, a personal ID, and a password, and further, speed information, destination information when a destination is set, and the like.

Reference numeral 25 denotes a display unit of the mobile wireless terminal 2. The display unit 25 includes a display such as an LCD (Liquid Crystal Display) or an organic EL and is configured to display a map and an icon of an operation button for a touch panel, and the like at an instruction from the control unit 20, and also display a content received from the server 3 and played back, information about a content when the content is audio information, and various information such as a map for navigation and route guidance information.

Reference numeral 26 denotes an input unit of the mobile wireless terminal 2. The input unit 26 includes a physical switch referred to as a numeric keypad and/or a touch panel.

Reference numeral 27 denotes an audio unit, which outputs an audio portion of a content received from the server 3 or read from the content storage unit 23a and played back. The audio unit 27 includes an amplifier, a speaker, and the like.

Reference numeral 28 denotes a navigation unit, which outputs a map around a current location on which a vehicle location is overlaid, and, when a destination is set, provides route guidance to the destination.

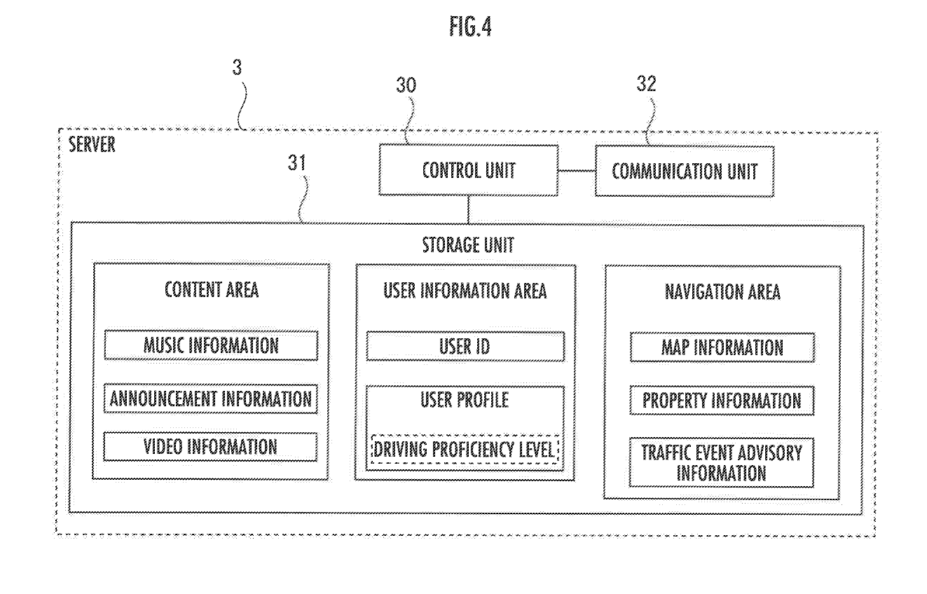

FIG. 4 shows a block diagram of the server 3.

The server 3 comprises a control unit 30, which includes a microprocessor and the like. The control unit 30 is configured to control each component unit, which will be described later. Note that in the present embodiment, a delivery server portion which comprises a function for delivering a content and a selection server portion which selects a content are described as a single server. However, a delivery server and a selection server may be different servers, or may be a distributed-type server such as a cloud server. The control unit 30 in the present embodiment uses a received vehicle speed for a driving concentration level, and therefore concurrently serves as a function of a driving concentration level setting unit of the present invention.

Reference numeral 31 denotes a storage unit (storage media). The storage unit 31 includes a semiconductor memory, a hard disk drive, and the like and stores various types of information, such as software referred to as an operating system (OS) and an application.

Various storage areas are secured in the storage unit 31. A content area stores various types of content information to be delivered to the content playback device 1 or the mobile wireless terminal 2. Specifically, the content information includes music information that is music contents, announcement information that includes announcements of a disc jockey, such as tourist information and current affairs, and announcements calling attention on accident-prone spots, sharp turns, and the like, and video information such as photographs and movies.

Each of the contents comprises, as tag information, information on a length of the content and information on a content level, which is categorized based on an information amount of the content. The information amount of a content is, for example, the number of words included in the content recognized through automatic recognition, or a numerical value assigned beforehand by an administrator of a content delivery server.

A user information area stores information similar to the driver profile information and the user profile information described above.

A navigation area stores map information including road information, and information on facilities stored along with latitudes and longitudes thereof and addresses and telephone numbers for search, and further, traffic event advisory information including objects that exist on roads and require attention on driving (hereinafter, such an object will be collectively referred to as a “traffic event” for convenience) and advisory levels thereof, each represented by the number of points.

Reference numeral 32 denotes a communication unit. The communication unit 32 is connected to the Internet circuit and a wireless communication network and is capable of communication with the vehicle 4 and the mobile wireless terminal 2. In the present embodiment, the communication unit 32 concurrently serves as functions of a reception unit and a transmission unit of the present invention.

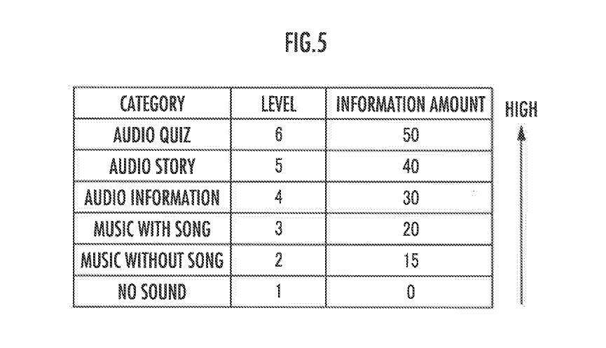

FIG. 5 shows a case example in which the contents stored in the content area of the storage unit 31 are classified by levels. The levels may be set to the contents according to categories of the contents, or the contents may be classified by levels on a basis of an information amount set to each content such that, for example, a content is classified as level 1 if 0≤ information amount <10; a contents is classified as level 2 if 10≤ information amount <20; a content is classified as level 3 if 20≤ information amount <30; a content is classified as level 4 if 30≤ information amount <40; a content is classified as level 5 if 40≤ information amount <50; and a content is classified as level 6 if 50≤ information amount <60. For the information amount of a content, for example, the number of words included in the content recognized through automatic recognition, or a numerical value assigned beforehand by an administrator of a content delivery server is stored.

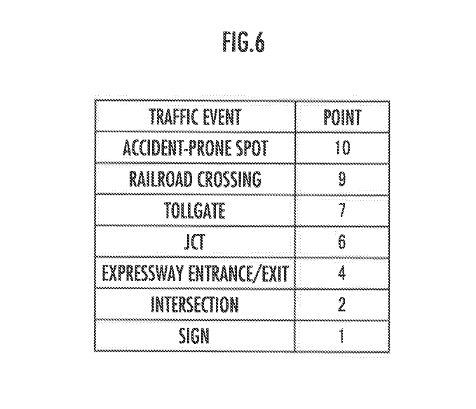

FIG. 6 shows an example of the traffic event advisory information. Each traffic event is given points, and a traffic event that requires more attention is given more points. In the present embodiment, a traffic event corresponds to an object of the present invention that requires attention on driving, and points correspond to an advisory level of an object of the present invention.

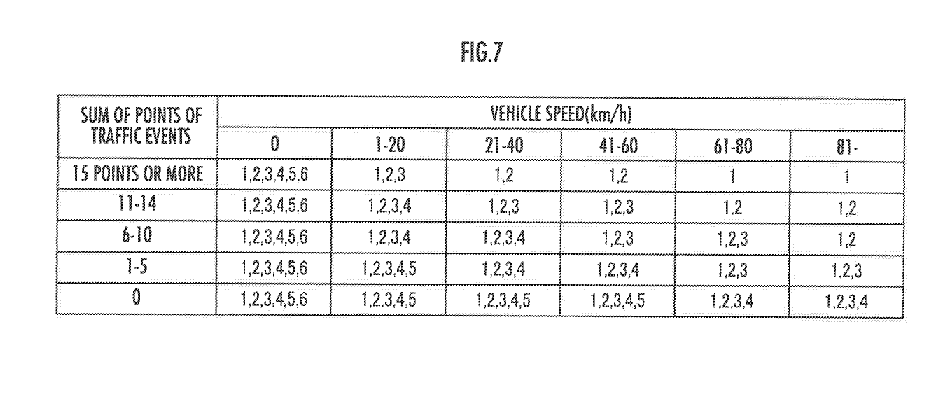

FIG. 7 shows content selection references. For the content selection references, one or more deliverable content levels are determined based on a correlation between a sum of points of traffic events existing within a predetermined distance from a current location and a vehicle speed, which indicates a driving concentration level. The predetermined distance from the current location may be a fixed distance, for example, 1 km, or may be configured to vary depending on a situation, such as 500 m on a high-volume road and 1 km on a low-volume road. Here, the driving concentration level is defined as a quantified indicator of a state where a driver should concentrate on driving. In FIG. 7, the vehicle speed is used for the driving concentration level. However, the driving concentration level of the present invention is not limited to the vehicle speed. Other examples of the driving concentration level will be described later.

If a destination is set, the predetermined distance from the current location on a route to the destination is a road along which the vehicle is going to travel. If a destination is not set, a traveling direction of the vehicle is determined based on a history of current locations or the like, and the predetermined distance from the current location along a road on the map information in the traveling direction can be estimated as a road along which the vehicle is going to travel.

Note that for the speed of the vehicle 4 that is a subject of comparison, an average speed in a constant time period, or a maximum instantaneous speed in a constant time period may be used, apart from the above-described current speed of the vehicle 4.

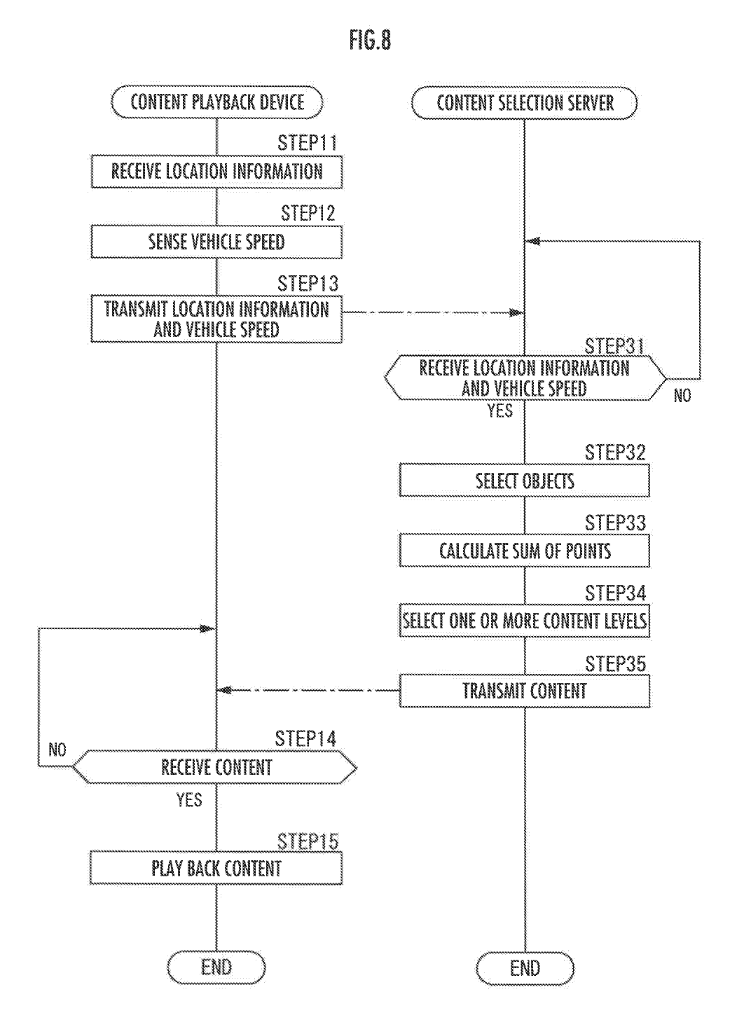

Next, a flow of processing steps in the content selection system (a content selection method) of the present embodiment will be described with reference to FIG. 8. A right flowchart in FIG. 8 shows a flow of processing steps in the content selection server 3, and a left flowchart in FIG. 8 shows processing steps in the content playback device 1 or the mobile wireless terminal 2.

First, in STEP 11, as a current location step, the content playback device 1 or the mobile wireless terminal 2 receives information on a current location of the vehicle by using the GPS sensor of the sensor unit 11 as the reception unit.

Next, processing advances to STEP 12, where, as a vehicle speed step, the content playback device 1 or the mobile wireless terminal 2 receives a vehicle traveling speed (vehicle speed) as a driving concentration level from the vehicle speed sensor of the sensor unit 11 provided in the vehicle 4. Note that the vehicle speed may also be calculated from time series variation in current location. In this case, an arithmetic operation of the vehicle speed may be performed by the content playback device 1 or the mobile wireless terminal 2, or may be performed by the content selection server 3.

Next, processing advances to STEP 13, where current location information and vehicle traveling speed information on the vehicle 4 are transmitted to the content selection server 3.

On the other hand, in STEP 31, as a driving concentration level setting step, the content selection server 3 checks whether or not the location information and the vehicle speed information are received from the content playback device 1 or the mobile wireless terminal 2. When the location information and the vehicle speed information are not received, the processing in STEP 31 is repeated.

Note that in STEP 31, when the location information and the vehicle speed information are received, processing advances to STEP 32, where, as an advisory information selection step, objects that exist within the predetermined distance of a road along which the vehicle is going to travel and that require attention on driving are selected, based on the vehicle current location and the vehicle speed, from the traffic event advisory information in the navigation area stored in the storage unit 31. Points as shown in FIG. 6 are assigned to each object.

Next, processing advances to STEP 33, where a sum of the points assigned to each of the selected objects is calculated. Next, processing advances to STEP 34, where, as a content selection step, one or more content levels corresponding to the calculated sum of the points and the vehicle speed are selected based on the map shown in FIG. 7, which is stored in the storage unit 31.

Next, processing advances to STEP 35, where, as a transmission step, the content selection server 3, based on the selected one or more content levels, transmits a corresponding content to the content playback device 1 or the mobile wireless terminal 2. Note that if a content is delivered from another server, the transmission step may be configured such that only the selected one or more content levels are transmitted.

In STEP 14, the content playback device 1 or the mobile wireless terminal 2 checks whether or not the content is received from the content selection server 3. When the content is not received, the processing in STEP 14 is repeated.

When the content is received in STEP 14, processing advances to STEP 15, where the received content is played back.

According to the content selection system of the present embodiment, a content can be selected in anticipation of a traveling environment of a road along which the vehicle is going to travel, while consideration is given to a viewing environment of a viewer such as a driver or a passenger.

In the present embodiment, it is possible to select a suitable content according to a traveling environment and a traveling speed, and to deliver the content to the vehicle 4. Moreover, by using the content playback device 1 in the present embodiment in a communication navigation system conventionally used, hardware conventionally included in the communication navigation system can be utilized, and provision of a content that is comfortable and effective to a viewer can be realized without adding new hardware dedicated to the content playback device 1.

### Second Embodiment

In a second embodiment, content selection references are varied in consideration of a driving proficiency level of a driver (a level of driver skill, proficiency information). That is, content selection references to be applied are changed between a driver with a high driving proficiency level (that is, a high level of skill) and a driver with a low driving proficiency level.

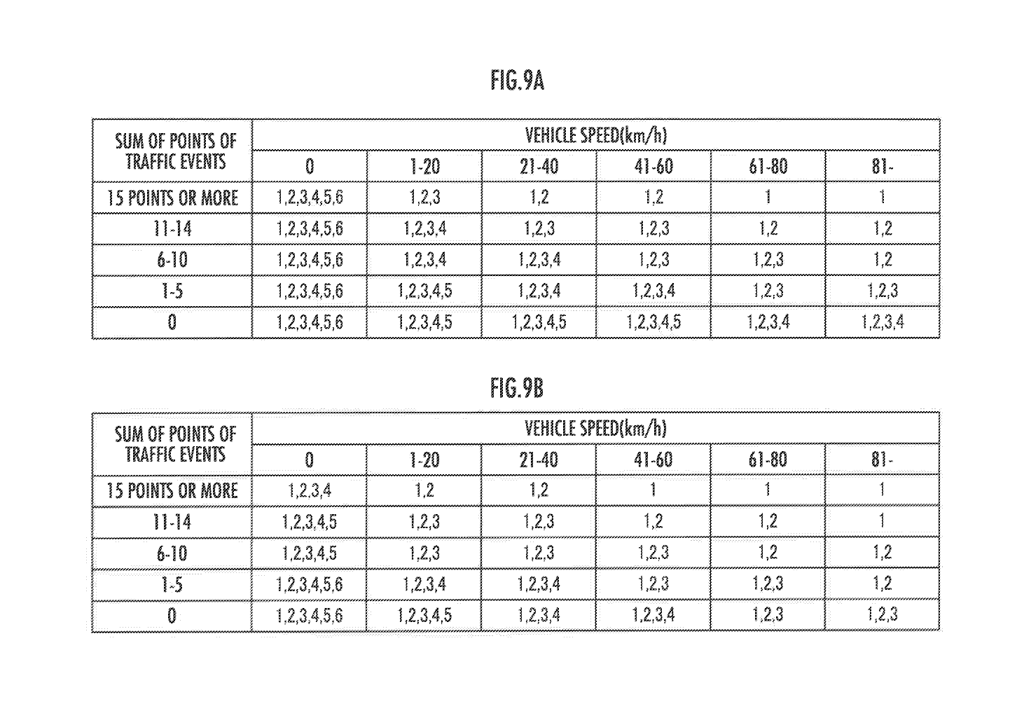

FIG. 9A shows an example of the content selection references for a driver with a high driving proficiency level, and FIG. 9B shows an example of the content selection references for a driver with a low driving proficiency level. The content selection references do not need to be prepared for two types as in the second embodiment, but may be broken down in more detail for three or more types depending on driving proficiency levels.

As shown in FIG. 9, contents of more content levels can be provided to the driver with the high driving proficiency level. For example, when drivers are driving in heavy traffic at vehicle speeds of 1 km/h to 20 km/h, and when a sum of the points of traffic events is 15 points or more, contents of the levels 1, 2, and 3 are provided to the driver with the high driving proficiency level, but contents of only the levels 1 and 2 are provided to the driver with the low driving proficiency level.

Note that a proficiency level (proficiency information) of a driver may be determined based on driving operation such as abrupt or slow operations of a steering wheel and a brake, or may be inputted beforehand by a driver from the input unit 16 or the input unit 26 on a self-reported basis.

The content selection method of the second embodiment can be implemented in such a manner that, before the flow in the first embodiment shown in FIG. 8 is performed, a plurality of content level maps, in which vehicle speeds and sums of the points of advisory information are associated with each other, are prepared beforehand as a proficiency step and changed, based on the proficiency levels (proficiency information) of drivers. Alternatively, as the proficiency step, the driving concentration levels set in the vehicle speed step or the like may be modified according to the proficiency levels (proficiency information) of drivers.

### Third Embodiment

In a third embodiment, the server 3 transmits a content category or content level information determined by the control unit 30 without including a content itself to the content playback device 1.

The content playback device 1 retrieves a content from the content storage unit 13a based on the received content category or content level information and plays back the content, or downloads a content that matches with the received content category or content level and plays back the content.

According to the third embodiment, a provider that instructs a content category or a content level and a provider that provides a content can separately run respective businesses. Moreover, if a content stored in the content storage unit 13a is played back, wireless communication for receiving the content does not occur, which leads to a reduction in communication expenses.

### Fourth Embodiment

In the first embodiment, for the content selection references shown in FIG. 7, it is described that a content is selected based on the traveling speed of the vehicle 4 (vehicle speed) as a driving concentration level. However, in a fourth embodiment, in place of the traveling speed of the vehicle (vehicle speed), a vehicle density on a road along which the vehicle is traveling (is going to travel) (a vehicle congestion level, a congestion level of a driving road, the number of other vehicles around the vehicle) is used in content selection.

For example, even at a same junction (a joining and branching spot), drivers more intently concentrate on driving when traffic is heavy, and therefore the number of vehicles that exist within a constant section is important in determination of a content.

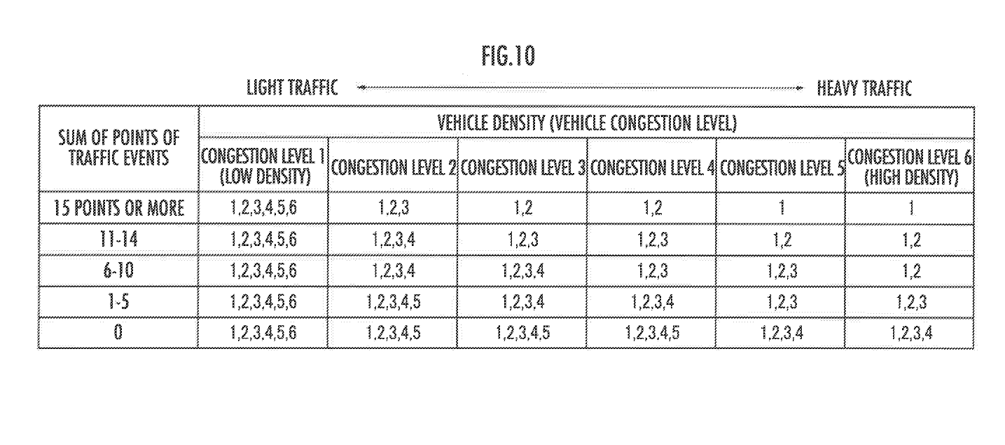

FIG. 10 shows content selection references in a case where a content is selected by using vehicle densities.

Note that for a method of calculating a vehicle density, a traffic counter on a road may be used, or a vehicle density may be estimated by compiling current location information uploaded to the server from a plurality of vehicles.

In the fourth embodiment, a density step of obtaining (receiving or estimating) a vehicle density may be provided in place of the vehicle speed step in the first embodiment.

Note that the driving concentration levels are not limited to the traveling speeds of the vehicle 4 (vehicle speeds) or to the vehicle densities on a road along which the vehicle is traveling (is going to travel), but other parameters may be used. For example, levels of sleepiness or fatigue of a driver measured by a sensor based on the number of blinks or the number of heart beats, and further, durations of driving and the like may also be used.

Further, the content playback device 1 itself may receive vehicle current location information and comprise a storage unit storing advisory information about objects that exist on roads and require attention on driving, and the control unit of the content playback device may comprise a function of the driving concentration level setting unit. In this case, the content playback device corresponds to a content selection device of the present invention.

### REFERENCE SIGNS LIST

1 Content playback device, 2 Mobile wireless terminal, 3 Server (Content selection device), 4 Vehicle, 10 Control unit, 11 Sensor unit, 12 Ignition information unit, 13 Storage unit, 13a Content storage unit, 14 Wireless unit, 14a Close proximity wireless communication unit, 14b Wireless communication network communication unit, 15 Display unit, 16 Input unit, 17 Audio unit, 18 Navigation unit, 20 Control unit, 21 Sensor unit, 23 Storage unit, 23a Content storage unit, 24 Wireless unit, 24a Close proximity wireless communication unit, 24b Wireless communication network communication unit, 25 Display unit, 26 Input unit, 27 Audio unit, 28 Navigation unit, 30 Control unit, 31 Storage unit, 32 Communication unit

1. A content selection server, comprising:
a reception unit configured to receive a current location of a vehicle;
a storage unit which stores advisory information about one or more objects that exist on one or more roads and require attention on driving;
a transmission unit configured to transmit information; and
a control unit which can select a content to be played back,
wherein the control unit
comprises a driving concentration level setting unit configured to obtain a driving concentration level, which is an indicator of a state where a driver should concentrate on driving, and
selects at least one category of the content to be played back based on the obtained driving concentration level, the current location of the vehicle, and the advisory information.

2. The content selection server according to claim 1,
wherein the reception unit can receive a traveling speed of the vehicle, and
the control unit obtains the driving concentration level based on the traveling speed of the vehicle received by the driving concentration level setting unit.

3. The content selection server according to claim 1,
wherein the control unit calculates a traveling speed of the vehicle from changes in the current location of the vehicle, and
the driving concentration level setting unit obtains the driving concentration level based on the calculated traveling speed of the vehicle.

4. The content selection server according to claim 1,
wherein the reception unit can receive or estimate a vehicle density on a road along which the vehicle travels, and
the control unit obtains the driving concentration level based on the vehicle density.

5. The content selection server according to claim 1,
wherein the control unit selects one or more objects that exist on a road within a predetermined distance from the current location of the vehicle and require attention on driving, calculates a sum of points of advisory level of the selected one or more objects that exist on the road and require attention on driving, and sets the advisory information based on a sum of points.

6. The content selection server according to claim 1,
wherein the storage unit stores a plurality of contents and category-specific tag information associated with each of the contents,
the control unit reads the content corresponding to the selected at least one category from the storage unit in a case where the at least one category of the content to be played back is selected by the control unit, and
the transmission unit transmits the read out content.

7. The content selection server according to claim 1,
wherein the storage unit stores proficiency information about a proficiency level of a driver who drives the vehicle, and
the control unit selects the at least one category of the content to be played back based on the current location of the vehicle, the driving concentration level, the advisory information, and the proficiency information.

8. A content playback device, comprising:
a reception unit configured to receive a current location of a vehicle;
a storage unit which stores advisory information about one or more objects that exist on one or more roads and require attention on driving; and
a control unit which can select a content to be played back,
wherein the control unit
comprises a driving concentration level setting unit configured to obtain a driving concentration level, which is an indicator of a state where a driver should concentrate on driving, and
selects at least one category of the content to be played back based on the obtained driving concentration level, the current location of the vehicle, and the advisory information.

9. The content playback device according to claim 8,
wherein the control unit can receive a traveling speed of the vehicle, and
the control unit obtains the driving concentration level based on the traveling speed of the vehicle received by the driving concentration level setting unit.

10. The content playback device according to claim 8,
wherein the control unit calculates a traveling speed of the vehicle from changes in the current location of the vehicle, and
the driving concentration level setting unit obtains the driving concentration level based on the calculated traveling speed of the vehicle.

11. The content playback device according to claim 8,
wherein the reception unit can receive or estimate a vehicle density on a road along which the vehicle travels, and
the control unit obtains the driving concentration level based on the vehicle density.

12. The content playback device according to claim 8,
wherein the control unit selects one or more objects that exist on a road within a predetermined distance from the current location of the vehicle and require attention on driving, calculates a sum of points of advisory level of the selected one or more objects that exist on the road and require attention on driving, and sets the advisory information based on a sum of points.

13. The content playback device according to claim 8,
wherein the storage unit stores a plurality of contents and category-specific tag information associated with each of the contents, and
the control unit reads the content corresponding to the selected at least one category from the storage unit in a case where the at least one category of the content to be played back is selected by the control unit, and plays back the read out content.

14. The content playback device according to claim 11,
wherein the storage unit stores proficiency information about a proficiency level of a driver who drives the vehicle, and
the control unit selects the at least one category of the content to be played back based on the current location of the vehicle, the driving concentration level, the advisory information, and the proficiency information.

15. A content selection method, comprising:
a current location step of obtaining a current location of a vehicle;
an advisory information selection step of, by a content selection device, based on the obtained current location, selecting advisory information about one or more objects that exist on a corresponding road and require attention on driving;
a driving concentration level setting step of, by the content selection device, obtaining a driving concentration level, which is an indicator of a state where a driver should concentrate on driving; and
a content selection step of, by the content selection device, selecting at least one category of the content to be played back based on the obtained driving concentration level, the current location of the vehicle, and the selected advisory information.

16. The content selection method according to claim 15, further comprising:
a vehicle speed step of receiving a traveling speed of the vehicle,
wherein in the driving concentration level setting step, the driving concentration level is obtained based on the received traveling speed of the vehicle.

17. The content selection method according to claim 15, further comprising:
a vehicle speed step of calculating a traveling speed of the vehicle from changes in the current location of the vehicle,
wherein in the driving concentration level setting step, the driving concentration level is obtained based on the calculated traveling speed of the vehicle.

18. The content selection method according to claim 15, further comprising:
a density step of receiving or estimating a vehicle density of a road on which the vehicle travels,
wherein in the driving concentration level setting step, the driving concentration level is obtained based on the vehicle density.

19. The content selection method according to claim 15,
wherein in the advisory information selection step, a plurality of objects that exist on the road within a predetermined distance from the current location of the vehicle and require attention on driving are selected, a sum of points of advisory level of the selected plurality of objects is calculated, and the advisory information is set based on the sum of points.

20. The content selection method according to claim 15,
wherein a storage unit stores a plurality of contents and category-specific tag information associated with each of the contents, and
the content selection method further comprises:
a reading step of reading, from the storage unit, the content corresponding to the at least one category of the content to be played back selected in the content selection step; and
a transmission step of transmitting the read out content.

21. The content selection method according to claim 15, further comprising:
a proficiency step of reading proficiency information about a proficiency level of the driver who drives the vehicle,
wherein in the content selection step, the at least one category of the content to be played back is selected based on the current location of the vehicle, the driving concentration level, the advisory information, and the proficiency information.

22. A content selection system which selects a content to be delivered from a delivery server, and received and played back by a content playback device, comprising:
a reception unit configured to receive a current location of a vehicle;
a storage unit which stores advisory information about one or more objects that exist on one or more roads and require attention on driving;
a transmission unit configured to transmit information; and
a control unit which can select a content to be played back,
wherein the control unit
comprises a driving concentration level setting unit configured to obtain a driving concentration level, which is an indicator of a state where a driver should concentrate on driving, and
selects at least one category of the content to be played back based on the obtained driving concentration level, the current location of the vehicle, and the advisory information.

23. The content selection system according to claim 22,
wherein the reception unit can receive a traveling speed of the vehicle, and
the control unit obtains the driving concentration level based on the traveling speed of the vehicle received by the driving concentration level setting unit.

24. The content selection system according to claim 22,
wherein the control unit calculates a traveling speed of the vehicle from changes in the current location of the vehicle, and
the driving concentration level setting unit obtains the driving concentration level based on the calculated traveling speed of the vehicle.

25. The content selection system according to claim 22,
wherein the reception unit can receive or estimate a vehicle density of a road on which the vehicle travels, and
the control unit obtains the driving concentration level based on the vehicle density.

26. The content selection system according to claim 22,
wherein the control unit selects one or more objects that exist on a road within a predetermined distance from the current location of the vehicle and require attention on driving, calculates a sum of points of advisory level of the selected one or more objects that exist on the road and require attention on driving, and sets the advisory information based on the sum of points.

27. The content selection system according to claim 22,
wherein the storage unit stores a plurality of contents and category-specific tag information associated with each of the contents,
the control unit reads the content corresponding to the selected at least one category from the storage unit in a case where the at least one category of the content to be played back is selected by the control unit, and
the transmission unit transmits the read out content.

28. The content selection system according to claim 22,
wherein the storage unit stores proficiency information about a proficiency level of the driver who drives the vehicle, and
the control unit selects the at least one category of the content to be played back based on the current location of the vehicle, the driving concentration level, the advisory information, and the proficiency information.
